(19) United States
(12) Patent Application Publication
(10) Pub. No.: US 2009/0292856 A1
(43) Pub. Date: Nov. 26, 2009

(54) INTERSERVER COMMUNICATION MECHANISM AND COMPUTER SYSTEM

(75) Inventors: Ryo TAKASE, Ebina (JP); Yutaro SEINO, Ebina (JP); Shisei FUJIWARA, Yokohama (JP)

Correspondence Address: FOLEY AND LARDNER LLP;SUITE 500, 3000 K STREET NW, WASHINGTON, DC, 20007, US

(73) Assignee: HITACHI, LTD.

(21) Appl. No.: 12/470,752

(22) Filed: May 22, 2009

(30) Foreign Application Priority Data
May 26, 2008 (JP) 2008-136943

(51) Int. Cl. G06F 13/00

(52) U.S. Cl. 710/316

(57) ABSTRACT

An interserver communication mechanism which can eliminate the need for preparing an external I/O device for each of physical servers for communication between the physical servers and can avoid generation of overhead caused by protocol conversion. A plurality of physical servers are connected to the interserver communication mechanism via I/O link and I/O switch. The interserver communication mechanism has a read instruction generator for issuing an instruction to access data of the physical servers and a write instruction generator for transmitting the read data to the other server. Data transfer between the physical servers is carried out in the interior of the interserver communication mechanism by reading out data from a data transmission originator, writing the read data to a transmission destination as it is, and directly turning back the data at the interserver communication mechanism.

### INCORPORATION BY REFERENCE

The present application claims priority from Japanese application JP 2008-136943 filed on May 26, 2008, the content of which is hereby incorporated by reference into this application.

### BACKGROUND OF THE INVENTION

The present invention relates to interserver communication mechanisms and computer systems and more particularly, to a computer system having two or more physical servers interconnected via an I/O switch and an interserver communication mechanism for establishing a communication between the physical servers in the computer system.

In recent computer systems, as the processing performance of a CPU is enhanced as when the performance of a CPU alone is increased or as when a CPU is made in the form of a multi-core, a need for server integration of a plurality of virtual servers in a computer as a single physical server is increasingly growing. Such a server integration enables increase in the number of OSs or applications to be operated on a single physical server, thus enhancing the performance of a computer system. As a result, in such a computer system, the number of I/O devices to be connected to single physical server computer is predicted to be increased. And for the purpose of mounting such many I/O devices, this type of computer system is increasingly required to be arranged to connect servers with an I/O switch such as PIC-Express (R) switch connected between the server and the I/O device.

In addition to the aforementioned approach to increasing the number of physical I/O devices connected to the servers with use of the I/O switches, it is also predicted that I/O virtualization of sharing an I/O device between the physical servers or between virtual servers is spread. The “I/O virtualization” means a method by which a plurality of virtual I/O devices are formed on a physical I/O device, and the virtual I/O devices are allocated to the respective physical servers or to the respective virtual servers, whereby the I/O device is shared between the physical servers or between the virtual servers.

In a computer system when it is desired to share an I/O device between a plurality of physical servers, such an I/O switch as to have a plurality of upstream ports and a plurality of downstream ports is prepared, the physical servers are connected to the upstream ports of the I/O switch, and the I/O device is connected to one of the downstream ports of the I/O switch. With such an arrangement, the I/O device can be shared between the plurality of physical servers. Employment of such I/O virtualization enables OSs or application programs operating on the interconnected servers to use much more I/O devices while avoiding the need for increasing in the number of physical I/O devices.

For such a computer system based on the server integration that a plurality of virtual servers are operated on one of physical servers, there is a demand for aggregating or reconfiguring the virtual servers operating on one physical server into another physical server. Moving the virtual server from one physical server to another physical server means that the contents or operating state of a memory being used by the virtual server is taken over the other physical server as it is. In other words, in order to move the virtual server from one physical server to another physical server, a large quantity of data of the memory relating to the operation is required to be shifted at a high speed, thus requiring a high-speed communication means between the physical servers.

As one of related arts relating to communication means for enabling high speed communication between computers, such a technique as disclosed in Patent Document 1 is known. In a multi-node computer system of the related art, a general-purpose I/O interface is used, a communication control device provided in each node interpret a transfer command for data transfer and controls the general-purpose I/O interface to attain high speed data transfer between nodes.

[Patent Document] JP-A-2006-58956

When the aforementioned related art is applied to communication between physical servers, an I/O device for interserver communication is connected to each physical server to attain communication between the I/O devices of the physical servers, thus establishing high-speed communication between the servers. In order to attain communication between all the physical servers using such a technique, it is necessary to connect the communication I/O device to each of the physical servers.

For this reason, the aforementioned related art has a problem that, when the art is applied to physical servers having a high integration formed as a typical blade server, the number of communication I/O devices necessary for attaining communication between the physical servers becomes too large.

Further, when the aforementioned related art is applied to physical servers using communication I/O devices to attain communication between the servers, different communication protocols are used between an interface of the physical server to the communication I/O device and an interface between the communication I/O devices. Thus, an overhead takes place due to protocol conversion for interserver communication. This undesirably leads to reduction of a communication throughput or to an increased communication latency.

The above problem with an increased number of communication I/O devices can be solved to a certain level by sharing the I/O device for interserver communication between the physical servers by utilizing the I/O virtualization technique. However, the problem with the overhead caused by the protocol conversion cannot be solved.

### SUMMARY OF THE INVENTION

It is therefore an object of the present invention to provide an interserver communication mechanism which can solve the problems in the above related art and can avoid occurrence of an overhead caused by protocol conversion while eliminating the need for preparing an I/O device connected as an external device for each physical server to attain interserver communication, and also a computer system using the interserver communication mechanism.

In accordance with an aspect of the present invention, the above object is attained by providing an interserver communication mechanism which includes a read instruction generating means (or portion) for generating a read instruction to read the contents of a memory, a return instruction receiving means (or portion) for receiving a memory data return instruction returned as a result of the read instruction, a data buffer for buffering memory data returned together with the memory data return instruction, a write instruction generating means (or portion) for generating an instruction to write the buffered memory data, and a destination information attaching means (or portion) for attaching destination information to the read instruction and the write instruction. In a plurality of physical servers interconnected via an I/O switch, data on the memory of the physical server as a data transmission originator is transferred to the memory of the physical server as a data transmission destination.

In accordance with the present invention, the need for preparing an I/O device as an external device for each of the physical servers to attain interserver communication can be eliminated, an overhead caused by protocol conversion can be avoided to increase an communication throughput, and a communication latency can be prevented from being increased.

Explanation will be made in detail as to an interserver communication mechanism and a computer system in accordance with embodiments of the present invention with reference to the attached drawings.

Other objects, features and advantages of the invention will become apparent from the following description of the embodiments of the invention taken in conjunction with the accompanying drawings.

### BRIEF DESCRIPTION OF THE DRAWINGS

FIG. 1 shows a block diagram of an arrangement of a computer system in accordance with a first embodiment of the present invention;

FIG. 2 shows a block diagram of an interserver communication mechanism;

FIG. 3 shows a sequence chart for explaining control when the interserver communication mechanism transfers memory data between physical servers;

FIG. 4 shows a block diagram of an arrangement of a computer system in accordance with a second embodiment of the present invention;

FIG. 5 shows a block diagram of an arrangement of a computer system in accordance with a third embodiment of the present invention;

FIG. 6 shows a block diagram of an arrangement of a computer system in accordance with a fourth embodiment of the present invention; and

FIG. 7 shows a sequence chart for explaining, as another example, control when the interserver communication mechanism transfers memory data between the physical servers.

### DETAILED DESCRIPTION OF THE EMBODIMENTS

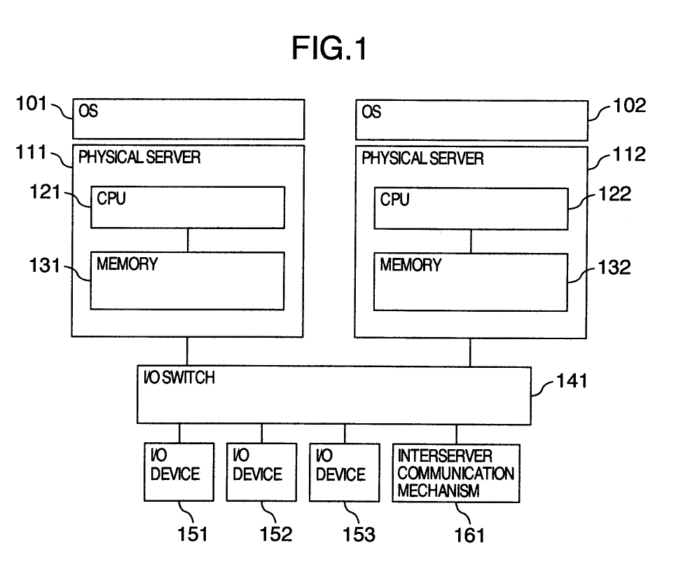

FIG. 1 shows a block diagram of an arrangement of a computer system in accordance with a first embodiment of the present invention.

In the computer system in accordance with the first embodiment of the present invention, a plurality of physical servers 111, 112 are connected to a plurality of upstream ports of an I/O switch 141 having the plurality of upstream ports and a plurality of downstream ports, and a plurality of I/O devices 151 to 153 and an interserver communication mechanism 161 are connected to the downstream ports of the I/O switch 141, so that OSs 101, 102 can be operated in the physical servers 111, 112. The physical server 111 has a CPU 121 and a memory 131, and the physical server 112 also has a CPU 122 and a memory 132.

In other words, the computer system of the first embodiment of the present invention is arranged so that the physical servers 111, 112 are connected to the I/O devices 151 to 153 via the I/O switch 141. Each of the I/O devices 151 to 153 may be an I/O device shared by both of the physical servers 111, 112, or may be an I/O device exclusively used by either one of the physical servers 111, 112. The interserver communication mechanism 161 for interserver communication in accordance with the present invention is connected to one of the downstream ports of the I/O switch 141, and further connected with the physical servers 111, 112 via the I/O switch 141.

In the above embodiment of the present invention, two physical servers and a single interserver communication mechanism are illustrated. However, more than the two physical servers may be provided and two or more such interserver communication mechanisms may be provided. With such an arrangement, even while a set of two servers are operated for interserver communication, another set of two servers can be operated for interserver communication concurrently with it.

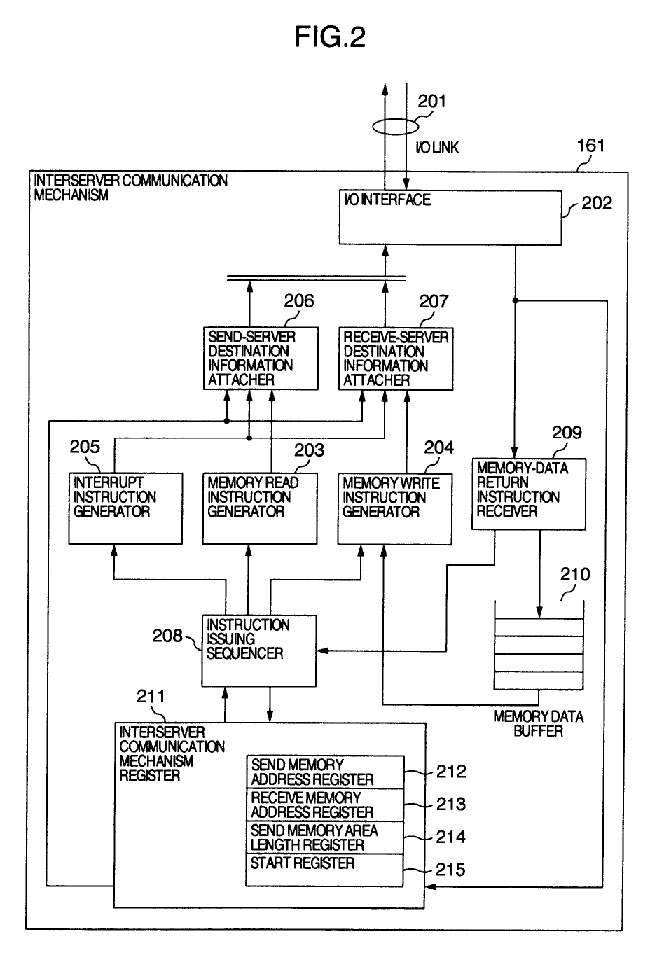

FIG. 2 shows a block diagram of an arrangement of the interserver communication mechanism 161. The interserver communication mechanism 161 is connected to the I/O switch 141 via an I/O link 201. The I/O link 201 is connected to an I/O interface 202 provided in the interserver communication mechanism 161.

The interserver communication mechanism 161 has a memory read instruction generator 203 for reading out data on the memory in the physical server, a memory write instruction generator 204 for sending memory data to another physical server, and an interrupt instruction generator 205 for generating an interrupt. The memory read instruction generator 203, the memory write instruction generator 204, and the interrupt instruction generator 205 are connected with a send-server destination information attacher 206 and a receive-server destination information attacher 207, as destination information attaching mechanisms for sending the instruction to the physical server of a correct destination. The interserver communication mechanism 161 includes a sequencer 208 for instruction issuance which controls the operations of the memory read instruction generator 203, the memory write instruction generator 204, and the interrupt instruction generator 205. The interserver communication mechanism 161 further includes a memory-data return instruction receiver 209 for receiving data read out from the physical server according to the memory read instruction, and also includes a memory data buffer 210 for storing the received memory data therein. The interserver communication mechanism 161 also includes an interserver communication mechanism register 211 as a software mechanism for controlling the interserver communication mechanism. The interserver communication mechanism register 211 has a send memory address register 212, a receive memory address register 213, a send memory area length register 214, and a start register 215.

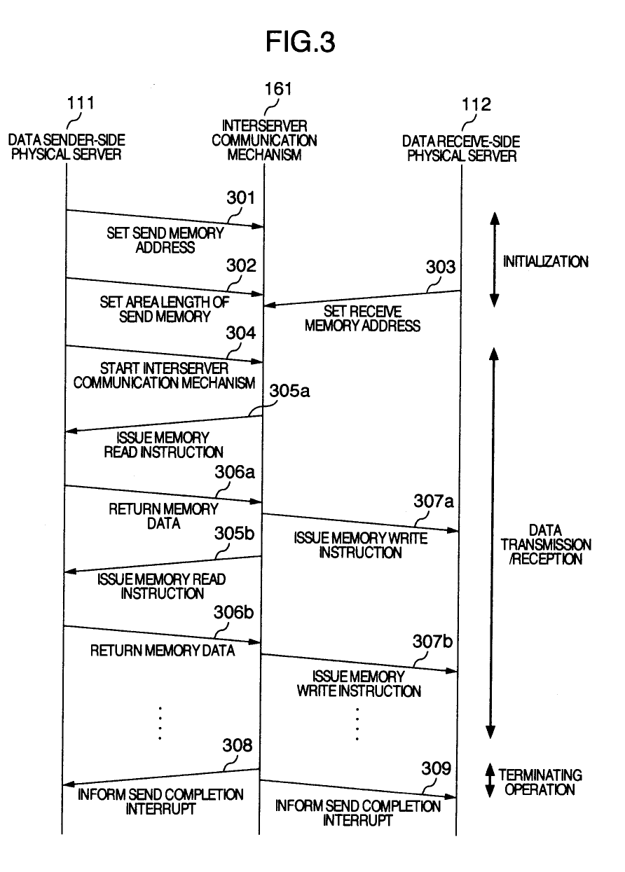

FIG. 3 is a sequence chart for explaining the control when the interserver communication mechanism transfers memory data between physical servers, which will be explained below. In this case, transfer of the memory data will be explained in connection with an example when data present in the memory 131 in the physical server 111 of the exemplified computer system of FIG. 1 is transferred to the memory 132 of the physical server 112.

(1) First of all, the OS 101 operating on the physical server 111 as a data send side sets a leading address for a send memory area. This setting is carried out by sending a write instruction from the physical server 111 as a data sender to the send memory address register 212 of the interserver communication mechanism 161 (step 301).

(2) Similarly, the OS 101 operating on the physical server 111 as a data sender performs writing operation over the send memory area length register 214 of the interserver communication mechanism 161 to set the size of the send memory area (step 302).

(3) The OS 102 operating on the physical server 112 as a data receiver similarly performs writing operation over the receive memory address register 213 of the interserver communication mechanism 161 to set the leading address of the receive memory area (step 303).

Initializing operation for interserver communication is completed with the aforementioned processing operations.

(4) When the OS 101 operating on the physical server 111 as a data sender then performs writing operation over the start register 215 of the interserver communication mechanism 161, the interserver communication mechanism 161 is started (step 304).

(5) When the interserver communication mechanism 161 is started, the instruction issuing sequencer 208 starts its operation, in such a manner that the memory read instruction generator 203 issues a memory read instruction attached with destination information about the physical server 111 of the data sender through the send-server destination information attacher 206. The memory read instruction is correctly transmitted to the physical server 111 of the data sender after passed through the I/O switch 141 with use of the destination information of the sender server (step 305a).

(6) The physical server 111 as the data sender, when receiving the memory read instruction, transmits a data return instruction containing the send memory data to the interserver communication mechanism 161, whereby memory data return is carried out for the memory read instruction of the step 305a. In this connection, the quantity of memory data transmitted by the first-time data return instruction is a predetermined quantity. When the quantity of data to be transmitted in the memory area is large, such a large quantity of data is divided into plural groups and then transmitted by a plural number of times (step 306a).

(7) The interserver communication mechanism 161 receives the data return instruction at the memory-data return instruction receiver 209, which in turn stores the memory data portion of the received instruction in the memory data buffer 210. When the interserver communication mechanism 161 receives the memory data, the memory write instruction generator 204 takes out the memory data from the memory data buffer 210, issues a memory write instruction containing memory data to be transmitted through the receive-server destination information attacher 207 at which destination information of physical server 112 of data receiver is attached to the memory write instruction. The memory write instruction is correctly transmitted to the physical server 112 of the data receiver with use of the destination information of the receiver server when passing through the I/O switch 141, (step 307a).

(8) When the instruction issuing sequencer 208 repetitively executes a series of operations, that is, the transmitting operation of the memory read instruction of the step 305a, the receiving operation of the memory read instruction of the step 306a, and the transmitting operation of the memory write instruction of the step 307a, until the transmission of a data length specified by the send memory area length register 214 is completed. At this stage, data transfer from the physical server 111 of the data sender to the physical server 112 of the data receiver is carried out (steps 305b, 306b, and 307b).

The operations of the steps 305b, 306b, and 307b are repeated until the transfer of the specified data length is completed, at which stage the data sending and receiving operation is completed.

(9) After the data transfer is completed, the instruction issuing sequencer 208 of the interserver communication mechanism 161 initiates the interrupt instruction generator 205. The interrupt instruction generator 205 issues an interrupt instruction to the physical server 111 of the data sender and also to the physical server 112 of the data receiver to inform the servers of the fact of the data transfer completion. The interrupt instruction generated by the interrupt instruction generator 205 is attached by the send-server destination information attacher 206 or the receive-server destination information attacher 207 with correct destination information, and then transmitted to the physical server 111 of the data sender and the physical server 112 of the data receiver respectively (steps 308 and 309).

After the operations of the steps 308 and 309, the data transferring operation between the servers is fully completed.

In the above first embodiment of the present invention, explanation has been made in connection with the example where the operations of instructing the interserver communication mechanism 161 to set and of starting the interserver communication mechanism are carried out by the OS which is regarded as an actor. However, the main operation may be implemented by a device driver for the interserver communication mechanism, in the form of an application program or the like, or in the form of a hypervisor or the like for managing a virtual server.

Although not shown in FIG. 1, the timing of starting the operations shown in FIG. 3 may be given by an instruction from a managing computer connected to the physical servers 111, 112, or by an instruction from a service processor formed in the physical servers 111, 112. As to the instruction, it may also be given automatically from the state of the physical server or by a system administrator or the like for the managing computer or the service processor.

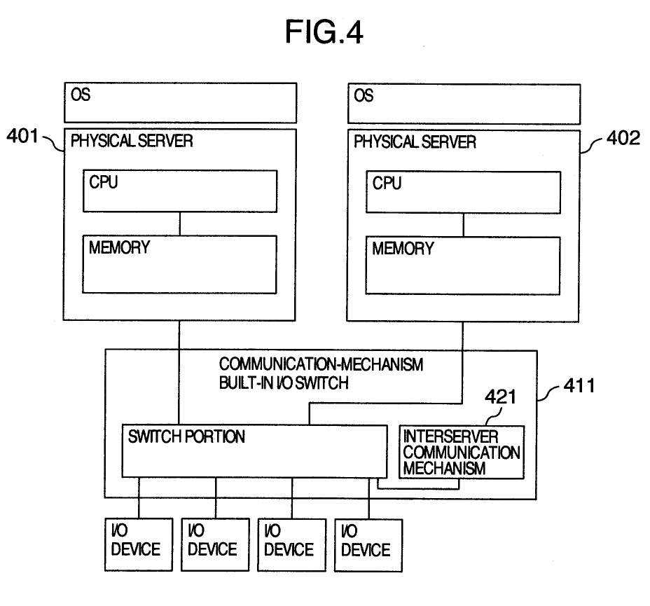

FIG. 4 shows a block diagram of an arrangement of a computer system in accordance with a second embodiment of the present invention. The second embodiment of the present invention shown in FIG. 4 is an example when an interserver communication mechanism is provided within an I/O switch.

The first embodiment of the present invention has been explained in connection with the example where the interserver communication mechanism 161 is provided as an external I/O device to be connected to one of the downstream ports of the I/O switch 141, by referring to FIGS. 1 to 3. The second embodiment of the present invention, on the other hand, is arranged so that, as shown in FIG. 4, an interserver communication mechanism 421 is incorporated in the I/O switch to form an I/O switch 411 having a communication mechanism built therein and to attain data transfer between physical servers 401 and 402.

Since the second embodiment of the present invention has such an arrangement as mentioned above, similarly to the case explained in connection with FIG. 3, the interserver communication mechanism 421 within the communication-mechanism built-in I/O switch 411 can provide mutual communication between the physical servers 401 and 402.

The second embodiment of the present invention have advantages that the need for exclusively using the downstream slot of the I/O switch to connect the interserver communication mechanism 421 can be eliminated and that the downstream slot of the I/O switch can be freed for another device. The second embodiment also has another advantage that, since the need for preparing the interserver communication mechanism 421 as an external device can be removed, a cost for introduction of the interserver communication can be reduced.

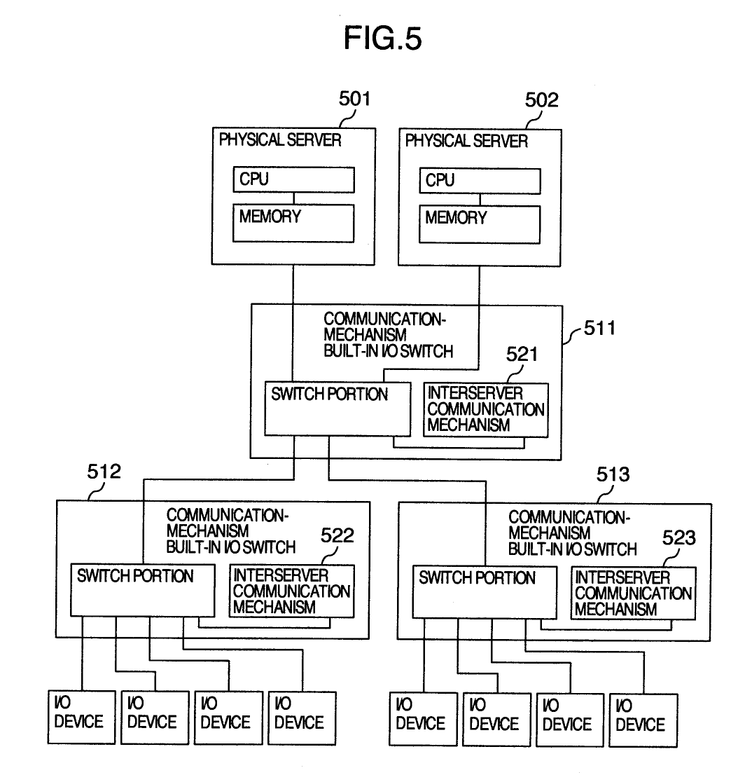

FIG. 5 shows a block diagram of an arrangement of a computer system in accordance with a third embodiment of the present invention. The third embodiment of the present invention shown in FIG. 5 shows an example of the computer system when multiple stages of communication-mechanism built-in I/O switches are provided in order to increase the number of I/O devices to be connected to physical servers.

In the computer system of the third embodiment of the present invention shown in FIG. 5, a plurality of physical servers 501, 502 are connected to upstream ports of a first stage of communication-mechanism built-in I/O switch 511, a second stage of a plurality of communication-mechanism built-in I/O switches 512, 513 are connected to the downstream ports of the first stage of communication-mechanism built-in I/O switch, and I/O devices are connected to a plurality of downstream ports of each of the communication-mechanism built-in I/O switches 512, 513 of the second stage. And interserver communication between the physical servers 501, 502 can be established by an interserver communication mechanism 521 built in the communication-mechanism built-in I/O switch 511 of the first stage.

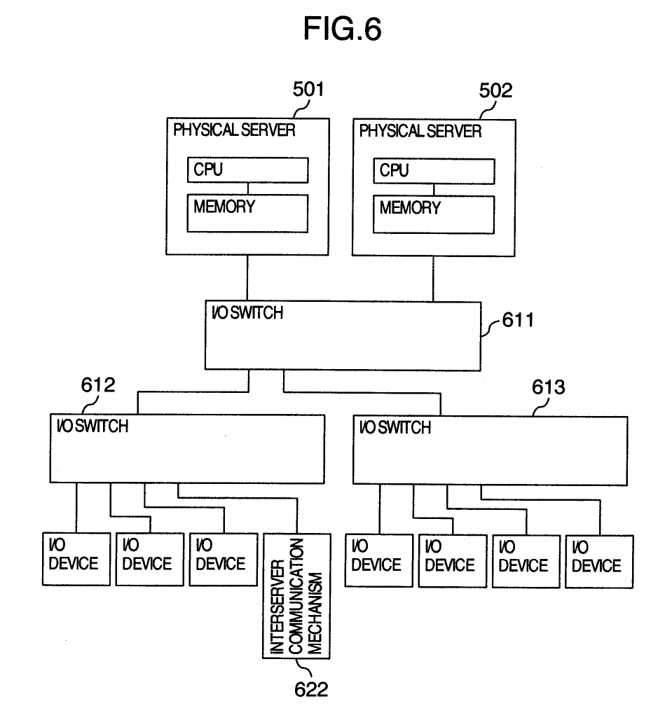

In accordance with the above third embodiment of the present invention, interserver communication can be established with use of the interserver communication mechanism within the first stage of I/O switch. Thus, a communication latency required for interserver communication can be reduced when compared with an example (to be explained later in connection with FIG. 6) when multiple stages of I/O switches each not having an interserver communication mechanism built therein are provided.

The computer system of the third embodiment of the present invention shown in FIG. 5 is arranged to include a single I/O switch as the first stage of I/O switch 511. In this example, however, a plurality of such communication-mechanism built-in I/O switches 511 may be provided, and 3 or more of the communication-mechanism built-in I/O switches 512, 513 may be provided. In this way, since the third embodiment of the present invention arranged as mentioned above is arranged so that the plurality of communication-mechanism built-in I/O switches of the first stage are connected to one of the communication-mechanism built-in I/O switches of the second stage; communication between physical servers, which cannot establish the communication with use of the interserver communication mechanisms within the different communication-mechanism built-in I/O switches of the first stage, can be established with use of the interserver communication mechanisms built in the communication-mechanism built-in I/O switches of the second stage.

FIG. 6 shows a block diagram of an arrangement of a computer system in accordance with a fourth embodiment of the present invention. The fourth embodiment of the present invention shown in FIG. 6 is an example when multiple (two in the illustrated example) stages of I/O switches each not having an interserver communication mechanism built therein are provided and an interserver communication mechanism is connected to one of the I/O switches of the second stage in order to increase the number of I/O devices to be connected to physical servers.

In the example of FIG. 6, more specifically, a plurality of physical servers 501, 502 are connected to an I/O switch 611 of the first stage, a plurality of I/O switches 612, 613 of the second stage are connected to the I/O switch 611, and I/O devices and an interserver communication mechanism are connected to the I/O switches 612, 613 of the second stage.

In the computer system of the fourth embodiment of the present invention shown in FIG. 6, since multiple stage of I/O switches each not having the interserver communication mechanism built therein are provided, it is required for interserver communication between the physical servers 501, 502 to be established with use of an interserver communication mechanism 622 connected to the I/O switch 612 of the second stage. Though not illustrated in FIG. 6, the I/O switch 613 of the second stage may also be arranged to be connected to the interserver communication mechanism.

In each of the foregoing embodiments of the present invention, the completion of data transmitting and receiving operations of the interserver communication mechanism has been informed to each the physical servers by issuing the interrupt instruction to the physical server as the data sender and to the physical server as the data receiver from the interrupt instruction generator. However, the present invention may be arranged so that the completion of the data transmitting and receiving operations may be informed to each physical server by another method.

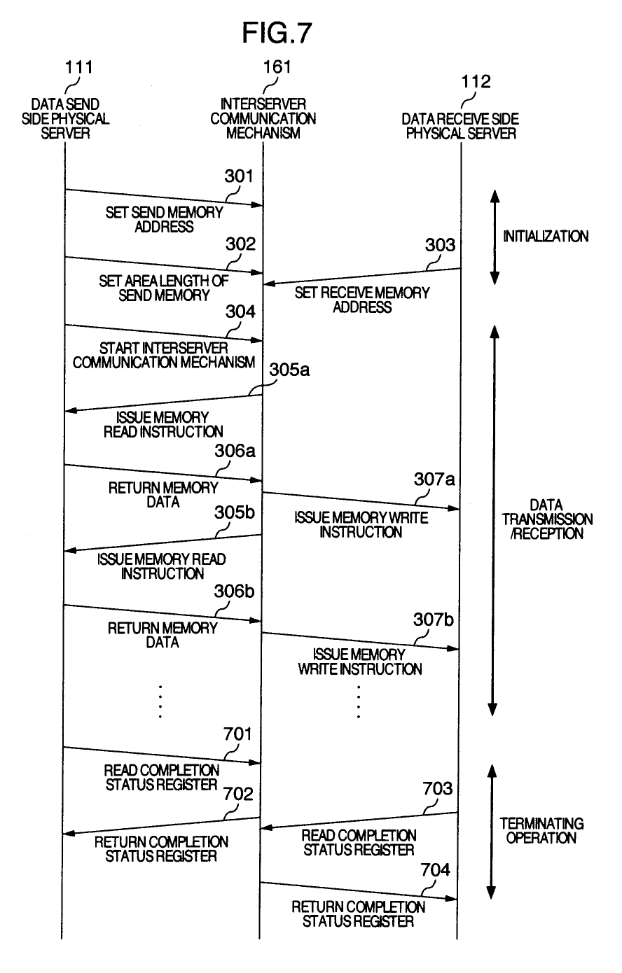

FIG. 7 is a sequence chart for explaining another example when an interserver communication mechanism controls transfer of memory data between physical servers, which will then be explained below. In the illustrated example, the memory data transfer is explained as in the case explained in connection with FIG. 3, in connection with the case of the computer system of FIG. 1 where data present in the memory 131 of the physical server 111 is transferred to the memory 132 of the physical server 112.

In the computer system of this example, a completion status register capable of being read out commonly by both of the physical servers of the data sender and receiver is provided in the interserver communication mechanism register 211 of the interserver communication mechanism 161. After completion of data transmitting or receiving operation, the interserver communication mechanism 161 registers the completion in the completion status register provided in the interserver communication mechanism register 211. When the physical servers read the completion status register by polling the completion status register, the physical servers of the data sender and receiver can know the completion of the data transfer.

The processing operations of steps 301 to 307b in FIG. 7 are the same as those already explained in FIG. 3 and explanation thereof is omitted.

(1) After data transmitting and receiving operations are completed in the operations of the steps 301 to 307b, the interserver communication mechanism 161 registers the completion in the completion status register provided in the interserver communication mechanism register 211. Thereafter, the interserver communication mechanism 161 receives a read instruction for the completion status register from the physical server 111 and returns the contents of the completion status register to the physical server 111 as the data sender (steps 701 and 702).

(2) Similarly, the interserver communication mechanism 161 receives the read instruction for the completion status register also from the physical server 112 as the data receiver, and returns the contents of the completion status register to the physical server 112 as the data receiver (steps 703 and 704).

The above example has been explained in connection with a case of using the completion status register. The present invention, however, may be arranged so that a read or write access can be similarly made to a single register within the interserver communication mechanism 161 from the data sender physical server 111 and also from the data receiver physical server 112. With such an arrangement, when the interserver communication mechanism modifies the status of the single register, the modified status can be informed to both of the physical servers as the data sender and receiver.

The operations of the foregoing embodiments of the present invention may be implemented each in the form of a program and the program may be executed by the interserver communication mechanism of the present invention. The program may be stored in a recording medium such as FD, CDROM or DVD and be provided. The program may be provided in the form of digital information through a network.

In the foregoing embodiments of the present invention, the number of external I/O devices for interserver communication to be provided for data transfer between physical servers can be decreased than the number of external I/O devices provided for each of physical servers in the prior art. Further, since the interserver communication mechanism is built in the I/O device, the need for providing an external I/O device for interserver communication can be eliminated.

In accordance with the embodiments of the present invention, since data communication between physical servers can be established within the interior of the interserver communication mechanism, an overhead cased by protocol conversion cannot be generated, which is advantageous from the viewpoints of a communication throughput and a latency.

According to the embodiments of the present invention, further, since the interserver communication mechanism is built in the I/O switch, the need for preparing an external I/O device for interserver communication for each of physical servers can be eliminated, and a cost required for employment of the interserver communication can be suppressed. In addition, the exclusive use of the slot of the I/O device by the I/O device for the interserver communication can be avoided and the freed I/O device slot can be effectively used. In such a system as to have multiple stage of I/O switches and an increased number of I/O devices, the interserver communication mechanism can be built even in a relay stage of I/O switch. As a result, interserver communication between physical servers connected to the relay stage of I/O switch can be turned back at the interserver communication mechanism built in the relay stage I/O switch and therefore a communication latency can be more reduced.

The embodiments of the present invention are effective, in particular, in such an application as to transfer a large quantity of memory data between servers without address conversion. For example, there is a case where a memory image in a virtual server has a large capacity and physical addresses which are continuous in area. In such a case, the present invention can be applied to such an application that a hypervisor uses the interserver communication mechanism of the present invention to attain the migration between virtual servers with the migration between physical servers, with great effects.

It should be further understood by those skilled in the art that although the foregoing description has been made on embodiments of the invention, the invention is not limited thereto and various changes and modifications may be made without departing from the spirit of the invention and the scope of the appended claims.

1. An interserver communication mechanism comprising:
a memory read instruction generating portion for generating an instruction to read contents of a memory;
a return instruction receiving portion for receiving a memory data return instruction returned as a result of the read instruction;
a data buffer for buffering the memory data returned together with the memory data return instruction;
a write instruction generating portion for generating an instruction to write the buffered memory data; and
destination information attaching portions for attaching destination information about the read instruction and about the write instruction,
wherein data present in a memory of one of a plurality of physical servers interconnected by an I/O switch as a data transmission originator is transmitted to a memory of the other physical server as a data transmission destination.

2. An interserver communication mechanism according to claim 1, wherein the interserver communication mechanism incorporates a control register, and the control register is read or written commonly by the plurality of physical servers.

3. An interserver communication mechanism according to claim 1, wherein the interserver communication mechanism is built in an I/O switch having a plurality of upstream ports and at least one downstream port.

4. A computer system comprising:
a plurality of physical servers each having at least one CPU and memory; and
an I/O switch having a plurality of upstream ports and at least one downstream port,
wherein the plurality of physical servers are interconnected by the upstream ports of the I/O switch, and
wherein the interserver communication mechanism set forth in claim 1 is connected to the downstream port of the I/O switch.

5. A computer system comprising:
a plurality of physical servers each having at least one CPU and memory; and
an I/O switch having a plurality of upstream ports and at least one downstream port,
wherein the physical servers are interconnected by the upstream ports of the I/O switch, and
wherein the interserver communication mechanism set forth in claim 1 is built in the I/O switch, and the downstream port of the I/O switch is connected with an I/O device.

6. A computer system comprising:
a plurality of physical servers each having at least one CPU and memory; and
I/O switches each having a plurality of upstream ports and at least one downstream port,
wherein the plurality of physical servers are interconnected by the upstream ports of one of the I/O switches, and
wherein the I/O switches are connected in the form of multiple stages, the physical servers are connected to the upstream ports of the I/O switch at highest one of the multiple stages, the interserver communication mechanism is built in each of the I/O switches set forth in claim 1.
